(19) United States
(12) Patent Application Publication
(10) Pub. No.: US 2008/0173670 A1
(43) Pub. Date: Jul. 24, 2008

(54) Systems and Methods for Temperature Management in the Dispensing of Bagged Fluids

(76) Inventor: Henry H. Macler, Felton, PA (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/939,719

(22) Filed: Nov. 14, 2007

Related U.S. Application Data
(60) Provisional application No. 60/865,800, filed on Nov. 14, 2006.

(51) Int. Cl. B67D 5/62; B65D 35/56; B67D 5/00; B67D 5/06; F25D 3/12

(52) U.S. Cl. 222/81; 62/530; 62/56; 165/132; 222/105; 222/185.1; 222/146.6

(57) ABSTRACT

Devices designed to aid the cooling of liquids in a flexible fluid container such as a bag being dispensed over time, generally through use of a dispenser which penetrates the membrane of the bag with at least one spike. The devices are cooling packs, adapted and sized to allow interaction with the fluid in the bag, while generally inhibiting damage to the pack from the spike. The devices are designed especially to cool liquid beverages such as water, without need to include an electromechanical cooling system in the dispensing device.

### CROSS REFERENCE TO RELATED APPLICATION(S)

This application claims benefit of and priority to U.S. Provisional Application Ser. No. 60/865,800, filed Nov. 14, 2006. The entire disclosure of which is herein incorporated by reference.

### BACKGROUND

1. Field of the Invention

This invention generally relates to systems and methods for temperature management in the dispensing of bagged fluids. More particularly, this invention relates to packages or containers comprising a material, such as a fluid or gel, that are generally put into proximity with bagged fluid for use in managing the temperature of the bagged fluid.

2. Description of the Related Art

Liquid storage vessels such as jugs or pitchers are essentially ubiquitous in society and have been around in a general form for centuries. A liquid storage vessel generally serves two purposes. It serves to contain a liquid so that the liquid does not spill, evaporate, or be soaked up by other objects from which it cannot easily be removed, and it serves as a way to dispense the liquid to users to drink, wash with, or otherwise utilize.

As technology has improved, the jug has become lighter, easier to use and store, and easier to handle and dispense from. At the same time, the general concept remains relatively unchanged. Most traditional vessels are shaped so the liquid is contained by gravity in a lower portion of the device. When the device is tilted or upended, the liquid is placed into contact with a hole or other opening which allows it to be dispensed to the user.

In the modern household, particularly in wealthier countries having a very high average standard of living, liquids to be consumed are often stored in a refrigerator. This allows for the liquids to be cold which often provides improved taste characteristics as well as making the beverage more refreshing to consume and, for some beverages, helping to preserve freshness for a longer time.

In some geographical areas and some, particularly less wealthy countries, refrigerators are not so common, or when available are fairly small and so are generally only used as required for food items that must be kept cold to be preserved, and do not include extra room to keep cold beverages that need not be preserved, such as water. These beverages are often, therefore, served at ambient temperature. It is known that the consumption of warmer fluids, such as water, is generally less palatable, and even relatively small decreases in temperature of a fluid can make the fluid significantly more palatable and can lead to an increased feeling of refreshment. Thus, alternate methods and devices are needed for temperature management of beverages, particularly water, when electric powered temperature management (refrigeration) is not as widely available.

In one technological advance, the storage and dispensing of beverages has been made easier through use of flexible containers, generally sealed bags, serving as the storage mechanism. The bag is then punctured by a sharpened spike which is part of the dispensing device. The spike/bag combination generally forms an enclosed pathway allowing for water to be dispensed from the bag without concern of undue contamination from outside elements as the water essentially is constrained in a fixed path from the bag to a valve and this water path is generally sealed from outside elements.

Dispensing systems and methods for bagged fluids have been extensively described in several U.S. patent applications, particularly including U.S. Patent Publications No. 20050077318, published Apr. 14, 2005 (application Ser. No. 10/926,604, filed Aug. 25, 2004), 20050092769, published May 5, 2005 (application Ser. No. 10/940,057, filed Sep. 13, 2004); and 20050121464, published Jun. 9, 2005 (application Ser. No. 10/973,052, filed Oct. 25, 2004), each of which is incorporated herein in its entirety by this reference.

Dispensing fluid from bags is particularly beneficial in locations which lack necessary infrastructure to provide for safe and sanitary community water sources and may be sufficiently small that the construction of water purifying plants is economically unfeasible. In these situations, the remote areas may lack resources to insure a clean water supply and may be dependent on wells and similar sources which can become, or may be, contaminated. Further, it is well known that in certain countries local microbial populations can have detrimental effect on visitors, and therefore businesses which provide food and beverage may wish to not utilize local water sources in such service to avoid such detrimental effects and cater to tourism.

Such communities and operations can be well served by a water purification and bagging facility as the bagging of clean water provides for easier transport and can provide for economies of scale in purification. Therefore, a purification and bagging plant can serve not one, but a large number of communities which are geographically dispersed. It is therefore possible for such a plant to be economically feasible as it can serve a greater number of individuals, without need to build expensive piping infrastructure. As the water is purified and then maintained in such purified form in the bags until it is dispensed, water can be cleaned, bagged, transported, stored, and then later dispensed without concern of the possibility of contamination being introduced to the water. Transport of such bags to remote locations can occur via trucks, animals, and other similar conventional transports, and storage can be by an end user or community storage location until the water is needed. As the dispensing and transport generally preserves the water from outside contamination, it provides for a safe and secure water source that would otherwise not be available.

The dispensing of bagged water can utilize various dispensers of a variety of shapes and sizes, some cylindrical and some rectilinear, for instance. Some of these dispensers have a lid and thereby completely enclose a fluid-filled bag, others leave the top of the fluid-filled bag exposed. Generally, however, these systems share certain common elements such as a storage location which supports the bag and a spike which is used to penetrate the bag membrane and connect the internal fluid to a valve or other dispensing mechanism. Generally, the fluid is provided on demand, so when the valve is actuated, fluid is allowed to flow from the bag through the valve until it is closed. Once closed, the water pathway is generally sealed from outside elements, maintaining the fluid in its generally purified form.

In more developed areas, the dispenser may include electrical components powered off of a standard wall outlet. These electrical components can provide for heating and cooling of the water prior to it being dispensed by the dispenser. The electrical components generally include heating or cooling coils to act on fluid transferred from the bag to an internal chamber to be heated or cooled prior to dispensing. Such systems, therefore, often utilize significant amounts of electricity as they are always maintaining a quantity of water at a temperature above or below ambient. In more remote areas, like the water infrastructure itself, electricity may be limited if available at all, and such electrical features as heating and cooling may be unusable or may be economically impracticable.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein are various devices designed to aid the cooling of liquids in a flexible fluid container such as a bag, specifically liquid beverages such as water, without need to include an electromechanical cooling system in the dispensing device. Specifically there are described “packs” which are designed to allow for heat transfer with the fluid in the bag when placed in proximity to the bag. The packs are not electrically powered, but instead can be cooled using a separate and often more efficient or cost effective cooling or heating device, and then provide cooling or heating to the fluid without need to maintain a constant electrical refrigeration or heating system directly on the fluid.

Described herein, among other things, is a pack for altering the temperature of a fluid, the pack comprising: an outer membrane having an outer surface and an interior surface wherein said membrane is arranged in a predetermined shape where said inner surface is entirely enclosed by said outer surface and wherein said predetermined shape includes a central opening; and a material arranged within the outer membrane and adjacent said inner surface; wherein said outer membrane is capable of allowing efficient heat transfer between said material and a substance in contact with said outer surface of said membrane.

In an embodiment of the pack the material is a fluid or a gel, which may be non-potable In another embodiment, the membrane and said material are the same substance.

In a further embodiment, the pack is generally circular, and may be toroidal, or may be generally rectilinear.

There is also described herein, a dispensing system for fluid, the system comprising: a dispenser, said dispenser including: a support, for holding a bag of fluid; a spike for penetrating an outer membrane of a bag of fluid; and a valve, said valve allowing fluid to transfer from said bag, into said spike and out said valve so as to be dispensed to a user; wherein said dispenser does not include an electrical heating element and does not include an electrical cooling element; a bag, said bag having an outer membrane and including fluid therein, said outer membrane being penetrated by said spike; and a pack for altering the temperature of a fluid, the pack comprising: an outer membrane having an outer surface and an interior surface wherein said membrane is arranged in a predetermined shape where said inner surface is entirely enclosed by said outer surface and wherein said predetermined shape includes a central opening; and a material arranged within the outer membrane and adjacent said inner surface; wherein said outer membrane of said pack is capable of allowing efficient heat transfer between said material and said fluid when said outer membrane of said pack is in contact with said membrane of said bag; wherein said pack is placed onto said bag at a position generally opposed to where said membrane of said bag is penetrated by said spike; and wherein said central opening of said spike will pass through said central opening of said pack without penetrating said outer membrane of said pack when said fluid in said bag has all been dispensed to said user.

In an embodiment of the system the material is a fluid or a gel, which may be non-potable. In another embodiment, the membrane and said material are the same substance.

In a further embodiment of the system, the pack is generally circular, and may be toroidal, or may be generally rectilinear.

There is also described herein, a method for altering the temperature of a fluid, the method comprising: providing a fluid dispensing system, the fluid dispensing system comprising a dispenser, said dispenser including: a support, for holding a bag of fluid; a spike for penetrating an outer membrane of a bag of fluid; and a valve, said valve allowing fluid to transfer from said bag, into said spike and out said valve so as to be dispensed to a user; wherein said dispenser does not include an electrical heating element and does not include an electrical cooling element; and a bag, said bag having an outer membrane and including fluid therein, said outer membrane being penetrated by said spike; providing a pack for altering the temperature of a fluid, the pack comprising: an outer membrane having an outer surface and an interior surface wherein said membrane is arranged in a predetermined shape where said inner surface is entirely enclosed by said outer surface and wherein said predetermined shape includes a central opening; and a material arranged within the outer membrane and adjacent said inner surface; wherein said outer membrane of said pack is capable of allowing efficient heat transfer between said material and said fluid when said outer membrane of said pack is in contact with said membrane of said bag; placing said pack onto said bag at a position generally opposed to where said membrane of said bag is penetrated by said spike; and allowing said spike to pass through said central opening of said pack without penetrating said outer membrane of said pack when said fluid in said bag has all been dispensed to said user.

In an embodiment, the method further comprises altering the temperature of said pack by placing said pack in a refrigerator external to said dispenser prior to placing said pack on said bag.

In an embodiment of the methods, the fluid is cooled by said method, while in another embodiment, the fluid is heated by the method.

### BRIEF DESCRIPTION OF THE DRAWINGS

FIGS. 1 and 2 show embodiments of prior art multi-bag fluid dispensing apparatus utilizing multiple fluid bags all of which are to be dispensed from or otherwise ruptured by a dispensing spike.

FIG, 3 shows an embodiment of a fluid dispensing apparatus with an embodiment of a temperature alteration pack deigned to avoid puncturing of the temperature alteration pack.

FIG. 4 shows an embodiment of a fluid dispensing apparatus with multiple temperature alteration packs.

FIG. 5 shows an alternate embodiment of a dispensing device for use in dispensing bagged fluids to which temperature alteration packs may be shaped to conform.

FIG. 6 shows a top down view of a generally toroidal temperature alteration pack which can be folded to provide for a more compact shape when cooling or freezing.

### DESCRIPTION OF THE PREFERRED EMBODIMENT(S)

The following detailed description illustrates by way of example and not by way of limitation. Described herein, among other things, is an embodiment of a temperature alteration pack designed for use with a liquid dispensing system utilizing bagged fluid.

In general, this disclosure will discuss the use of “packs” or more specifically “temperature alteration packs” which are designed to provide for temperature management and alteration of temperature of a fluid being dispensed from a bagged fluid dispensing system. This disclosure will generally refer to the fluid as water because water will be a fluid commonly dispensed in such a system. However, the use of water as fluid is merely exemplary and one of ordinary skill in the art would understand that the dispensing system could dispense any type of fluid.

The temperature alteration packs discussed herein may be used with a variety of different bagged fluid dispenser configurations and will generally be sized and shaped to correspond to the particular system with which the pack is intended to be used. As such, any discussion of shape and arrangement of components in the pack is merely exemplary to the specific dispensing device being discussed and one of ordinary skill in the art would understand how to select different sized and shaped packs to correspond to different sizes and shapes of dispensers.

It should be recognized that the temperature control packs discussed herein can be used for both heating and/or cooling of the fluid to be dispensed. Generally, however, cooling is a more technology complex problem to solve as heat (in the form of flame) is relatively easily obtained even in remote locations. However, cooling often relies upon electrical devices that are maintained over time. For this reason, this disclosure will focus on cooling, however, one of ordinary skill in the art would recognize that the principles of temperature management as applied to cooling the fluid can be just as easily applied to heating the fluid by simply increasing the temperature of the pack instead of decreasing it.

In general herein, cooling and heating will be discussed as being accomplished with use of a temperature control pack, either by cooling or heating the pack prior to use. Cooling or heating of such a pack can by accomplished by any reasonable means and will generally be accomplished at a location separate from the dispensing. Heating of a pack can be accomplished, for instance, in a conventional gas or electric oven, in a microwave oven, on the stove, such as in boiling water, or over an open fire. Cooling can occur, for instance, in a typical electric powered refrigerator or freezer, an ice box or other ice-cooled environment, a large industrial or purpose built refrigerator or freezer, or even a naturally occurring cooling source such as cool muds, standing or free flowing water sources, caves, or similar sources.

Generally, the dispensing systems or “dispensers” (101) to dispense bagged fluid which will be used with the temperature alteration packs discussed herein will share a number of common components. Specifically, there will generally be a support construct (103) which will serve to support the fluid filled bag (401) from which the fluid is being dispensed. This construct (103) will include at least one spike (201) which is designed to puncture the membrane of the bag (401) and allow for the fluid in the bag (401) to flow through the spike (201) and into a dispensing pathway (209) which is controlled by a valve, spigot (111) or other construct to provide for controlled dispensing, generally on demand

In the current discussion, an assumption of the location of the dispensing device (101) is that it is in a location where there is insufficient infrastructure, or it is economically unfeasible, to cool or heat the liquid within the dispenser (101) by placement of the fluid into an internal chamber where it can be stored and temperature modified prior to dispensing. That is, a traditional “office water cooler” which includes refrigeration and/or heating coils would not be useable or would be economically unfeasible. Instead, the dispensing system is designed relatively simply to provide for the function of dispensing in a controlled manner and for maintaining the water pathway in a manner which inhibits the introduction of outside contamination. Cooling (or heating) technology is available but is either limited to being provided at a larger community location, or more specifically is available to an individual in the form of a small device separate from the dispensing device, such as a small cube refrigerator.

It is recognized that fluids to be dispensed by the dispenser may be cooled directly by either refrigerating the bag (401) directly prior to it being placed in the support (103), or by the addition of ice to the fluid in order to provide for cooling directly. These options, while effective, are often only suitable for short term maintenance of cooler temperatures. Even in insulated containers, the fluid in the bag (401) will slowly equalize to ambient and, once the ice has melted, even these systems will gradually return to ambient temperature. As it is generally difficult to remove the bag (401) from the dispenser, once it has been punctured by the spike, without loss of fluid, such solutions are therefore unviable if fluid in the bag (401) lasts longer than it takes for the temperature to equalize with the ambient. Further, addition of ice to an otherwise sealed bag (401) is very difficult and can also result in contamination of the fluid by outside contaminants which is undesirable. Further, the bag and or dispenser and bag combination are often too large to be placed directly within the cooling device.

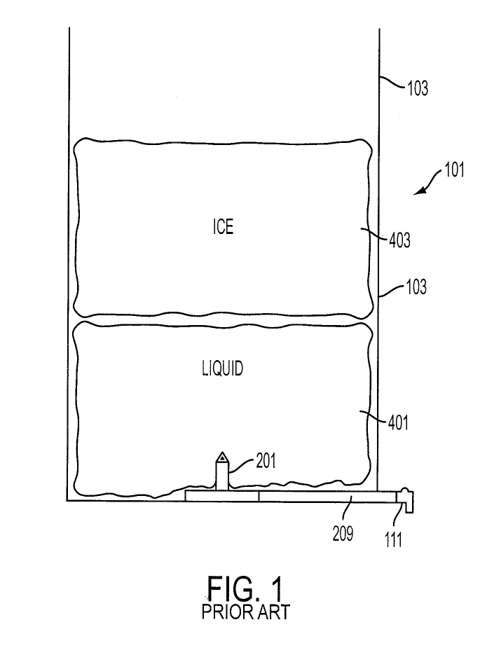

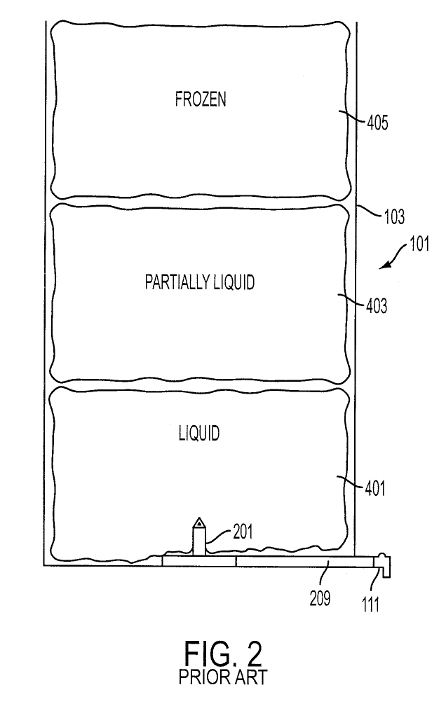

In U.S. Pat. No. 7,165,700 there is described a system including an insulated container in which is placed multiple bags of fluid some of which are provided at an initially decreased temperature. FIGS. 1 and 2 herein illustrate how such as system can be utilized to provide for cooling of materials by having a first bag of fluid onto which is provided a second bag or even third bag which have been frozen or otherwise cooled. Heat transfer then results in a cooling of the fluid in the bag which is being dispensed from. As described in U.S. Pat. No. 7,165,700, an advantage of an embodiment of this system and method is that after the first-dispensed fluid bag is empty, a second bag containing previously frozen fluid will automatically be opened (e.g., punctured with a spike), and can be immediately dispensed from.

Such a system is shown in FIGS. 1 and 2, the use of which is described as follows. A user obtains a first bag (401) of fluid and a second bag (403) filed with fluid or ice, or filled with a fluid and then frozen in the bag (403) (in an embodiment, frozen in a mold to insure the bagged frozen block fits within the dispenser (101)). Both bags are then placed in the dispenser (101) one on top of the other. If the second bag (403) contains ice, it will generally be placed on top of the first bag (401) within the dispenser (101), in order to allow access to fluid in the first bag (401) via the spigot (111). Where the second bag (403) contains ice, the melting ice will cool the fluid in the first bag without diluting it. Alternatively, the same bag (403) could be used to heat the fluid being dispensed by heating the bag (403) prior to use.

Further, once the fluid in the first bag (401) has been fully dispensed, the first bag (401) can be removed and the second bag (403) can be put back into the portable water cooler (101) and now penetrated by the spike (201) to allow dispensing of the melted ice. Generally, neither the first bag (401) nor second bag (403) is removed after fully dispensing from the first bag (401), but rather the weight of the second bag (403) forces the second bag (403) onto the spike (201) to allow dispensing therefrom. An embodiment with three bags using ice is shown in FIG, 2 where three bags (401), (403), and (405) all contain fluid in various stages of thaw. This embodiment can be used much like the two bag system of FIG. 1 but with greater versatility.

While this arrangement provides for a non-electromagnetic cooling system for the dispensed fluid, it has a number of problems in situations where external refrigeration may be limited. In the first instance, as the second (403) or subsequent bag (405) is essentially the same size as the initial bag (401), the amount of space in an external refrigerator or freezer that is required to cool the second (403) or subsequent bag (405) is the same as if the original bag (401) had been cooled. If such space is not available, there is no way to cool any of the bags, and if such space is available, the first bag (401) could be cooled directly, and then placed in the dispenser to provide for more direct cooling which may be considered at least somewhat more efficient.

A second problem is that the second (403) or subsequent bag (405) is susceptible to being punctured by the spike (201) even if it is not intended to be dispensed from. It therefore generally must include potable fluid to avoid any contamination of the dispensing cooler (101) in the event the bag (403) is ruptured by the spike (201) This means that high efficiency cooling or heating chemicals which should not be consumed cannot be used in the bag (403) or (405). Still further, the bag (403) or (405) which is intended for temperature management must be placed above the bag (401) which is being dispensed from which may not be preferred.

In an embodiment, the reason for not wanting to puncture a bag utilized for temperature alteration is that it contains a fluid that is not potable, which chemical may be used because it has thermal properties more desirable than potable fluid in heat transfer. In another embodiment, preventing puncture is desired because by not puncturing the temperature alteration pack, the temperature alteration pack can be reused (and specifically sized for reuse), and thus efficiency of use can be increased, since the user will not have to make or buy a new temperature alteration pack each time one is desired to be used and the pack can be sized and shaped to improve heat transfer, instead of to hold potable fluid.

In an embodiment, instead of utilizing additional fluid bags (403) or (405), there is provided a temperature alteration pack (305) which is specifically designed not to interact with the spike (201). In an embodiment, the temperature alteration pack (305) is formed of an outer membrane (311) having inner (317) and outer surfaces (315). The outer surface (315) is designed to completely enclose the inner surface (317) and the internal area (adjacent the inner surface) is filled with material (319) to provide for heat transfer. The pack (305) is then formed to have a central opening (301), through which the spike (201) can pass without puncturing the outer membrane, even when the bag (401) of fluid being dispensed is empty.

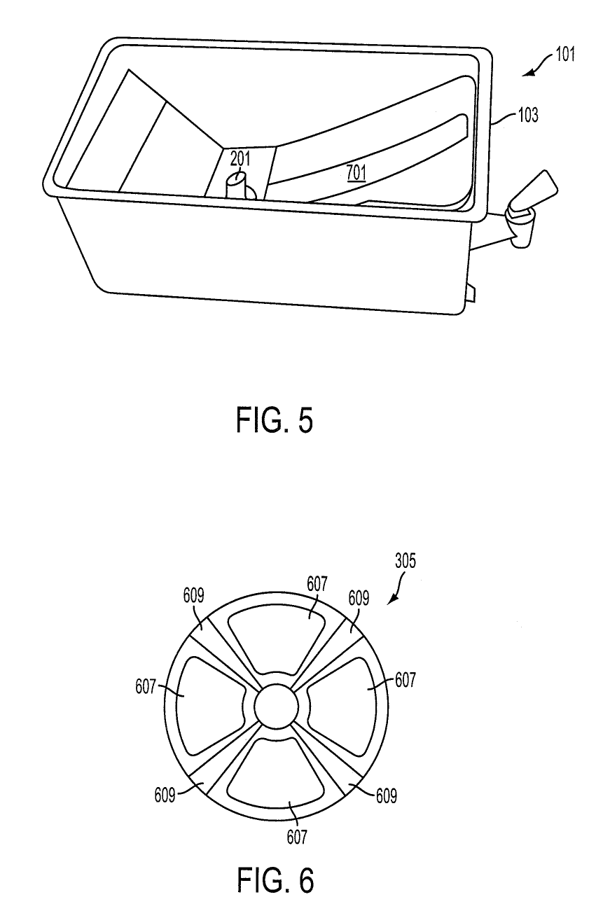

FIG. 3 illustrates a cross-sectional view, and FIG. 6 a top view, of embodiments of such a temperature alteration pack (305), which is generally circularly shaped (a toroid) and which includes a central opening (301) through which the spike (201) will pass when the temperature alteration pack (305) sinks downward toward it. This central vertical opening (301) can pass the spike (201) without the spike (201) penetrating the temperature alteration pack (305). As described above, as the weight of the second bag (403) would usually result in the second bag (403) being punctured by the spike (201), the central opening (301) ensures that the spike (201) will not puncture the temperature alteration pack (305). Instead, as the bag of fluid (401) is dispensed and emptied, the temperature alteration pack (305) drops toward the bottom of the cooler (101), and the spike (201) projects into (or through) the central opening (301). This shape can provide an additional benefit of generally forcing fluid in the bag (401) toward the center (due to the mass of the temperature alteration pack (305) being toward the outside) and into the spike (201).

It should be apparent that a smaller central opening (301) is preferred as it maximizes the surface area contact between the outer membrane (311) of the pack (305) and the membrane of the bag (401). As the membrane (311) of the pack (305) will generally be designed to allow for effective transfer of heat between the material in the pack (305) and the fluid, an increase in surface area contact will generally result in improved temperature management. In an embodiment, the other (in this case upper) surface (321) of the pack (305) may be made of a different material so as to inhibit temperature transfer between the pack (305) and ambient air.

While a toroidal shape is generally preferred for situations in which the spike (201) projects essentially from the geometric center of a generally cylindrical, or similarly shaped, dispenser (101), one of ordinary skill in the art will recognize that any shape with a central opening, cavity, hole, or other accommodation for prohibiting interaction of the spike (201) with the temperature alteration pack (305) may be used.

In an alternate embodiment, there is an additional temperature alteration pack (355) positioned on another side of the fluid-filled bag (401) being dispensed. FIG, 4 shows such an embodiment, wherein a temperature alteration pack (355) is on the bottom of the cooler (101) and is generally toroidally shaped, having the spike (201) already project through its central opening to puncture the first bag (401) for dispensing of fluid therefrom. In such an embodiment, the bottom temperature alteration pack (355) is placed into the cooler first, followed by the first bag (401) and the top temperature alteration pack (305), in that order.

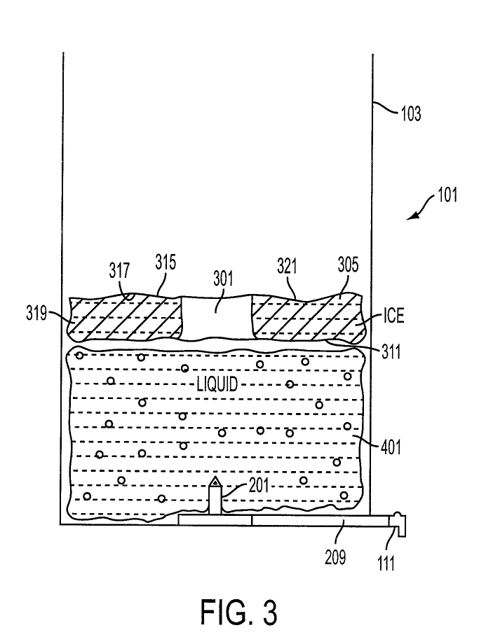

Further alternate embodiments include bagged fluid dispensing apparatuses having more than one other temperature alteration pack, i.e., more than two total temperature alteration packs, and dispensing apparatuses with the temperature alteration packs placed in different locations relative to the fluid-filled bag (401). In an embodiment, regardless of whether a temperature alteration pack is positioned at the bottom of the support (103) or on top of the fluid-filled bag (401), such as temperature alteration pack (355) and temperature alteration pack (305), respectively, shown in FIG. 4, a temperature alteration pack is wrapped around the fluid-filled bag (401). Moreover, temperature alteration packs may be inserted into or may form the walls of the container (101) from which fluid is dispensed. In these alternate embodiments, the temperature alteration packs and the fluid-filled bag (401) may be positioned within the container (101) in various orders.

While the temperature alteration packs (305) and (355) have been discussed above simply as specially shaped fluid-filled bags, generally, the temperature alteration packs (305) and (355) may be of any construction, made of a membrane (311) designed to transfer, and an internal material (319) designed to absorb, heat. In particular, the temperature alteration packs (305) and (355) may be solid, uniform blocks of material, or may be multi-material constructions, such as having a durable outer membrane (311) that may be plastic or any other durable material and another inner material (319) that is particularly suited to absorbing heat, for instance a fluid solution or a fluid mixture or a gel or a mixture that undergoes reversible or irreversible chemical reaction that may aid in the cooling or heating process, such as would an endothermic or exothermic reaction, respectively. In alternate embodiments, the outer membrane (311) of a temperature alteration pack (305) or (355) is constructed of flexible material or is constructed of substantially rigid material that will hold shape after manufacture. In a further embodiment, the temperature alteration pack (305) or (355) is particularly sized to be of less volume than a standard fluid-filled bag (e.g., 401), and still further particularly sized to fit well into the small volume ice box of a small refrigerator (e.g., as is sometimes termed a cube refrigerator).

FIG. 6 provides for an embodiment of a temperature alteration pack (305) which can be made into a more compact shape when it is to be cooled so as to fit in a more compact area, such as in the freezer compartment of a cube refrigerator, which is too small to hold a fluid filled bag (401). In this embodiment, the temperature alteration pack (305) is comprised of a toroid having four filled parts (607) arranged around its structure. Between each of these is a flexible portion (609) comprised of only a thin film. The pack (305) can be effectively compressed into a differently shaped area by having the pack (305) fold within the areas (609) to form a more cubical arrangement. In particular, into a shape having roughly ¼ the horizontal area but 4 times the vertical area. As the pack (305) will often be wider than it is tall to insure coverage of a maximum surface area of the bag (401) when in the dispenser (101), this can provide for a more cubical shape when the pack (305) is to be frozen or chilled. The pack (305) in this configuration can be sized and shaped so that when it is folded it fits in the freezer portion of a small refrigerator when the freezer portion is not otherwise in use. If the membrane (311) is filed with chemicals which are designed to freeze quicker than water, it may take less time to cool the temperature alteration pack (305) than the same volume of water. The pack (305) can then be removed and unfolded, being placed on top of the fluid as shown in FIG. 3.

For temperature alteration packs (305) having an inner fluid or gel material (319), in alternate embodiments, the temperature alteration packs (305) are either pre-filled and pre-sealed, or are empty to be filled and sealed by the user. The pre-filled and pre-sealed packs (305) generally provide for more options for filling material (319) as there is no need for the user to handle or interact with the material (319). Therefore the material (319) can be non-potable, and even poisonous, so long as it is sealed and generally inaccessible. As the pack (305) is designed not to be penetrated by spike (201) due to the presence of the central opening (301), the material (319) filling the pack (305) would generally not come into contact with the fluid pathway (209).

Allowing the user to fill packs (305) with whatever material is handy allows the user to empty the pack (305) when it is not being used which provides for more ready storage. However, it does require the user to have access to a filling material (319). However, since, again, the material (319) in the pack (305) will not come into contact with the fluid passageway (209), the material (319) need not be potable water and non-potable water, among other things, may be used to fill the pack (305).

In various embodiments, the temperature alteration packs (305) are filled with liquid, a gel, or a similar material that does not solidify until temperatures much lower than the freezing point of water are reached (0 C) Especially when the temperature alteration packs are pre-filled, they may contain specialized heat absorbing materials, such as gels, which can be manufactured to have a high heat capacity and are not as likely to leak to the same extent as would a less viscous fluid in the event of a damage to the outer membrane (311) of the temperature alteration pack (305). Further, the inner materials (319) used in the temperature alteration pack (305) may be specifically chosen to aid in the efficiency of the cooling process, such as accelerating the time for chilling of the temperature alteration pack (305) prior to use in the bagged fluid dispensing apparatus (101), or for being able to hold a temperature far below the freezing temperature of water. The temperature alteration packs (305) may also be designed to have internal reactions related to the heating or cooling. For example, instead of the material (319) transitioning from a liquid to a solid state, or even simply absorbing cold from the refrigerator, the material (319) may actually include a chemical reaction which improves the speed or duration of the heat transfer.

Should the temperature alteration pack (305) completely thaw or otherwise be sufficiently used to no longer provide sufficient cooling to the fluid, the pack (305) will generally be returned to the refrigerator or freezer to be chilled again and reused. In an embodiment, this may occur, for example, overnight For example, the chilled pack (305) may be placed on the water bag (401) in the morning and chill the water for the most part of the day. In the evening, the pack (305) may be returned to the freezer compartment of the refrigerator as the water will probably not be drunk during the night. The water will also generally maintain a cooler temperature at night due to the reduction in air temperature which usually occurs. On the next morning as the ambient temperature begins to rise, the temperature alteration pack (305), which has been frozen overnight, is returned to the dispenser (101) and again placed on the bag (401) to maintain a cooler temperature and the process is repeated.

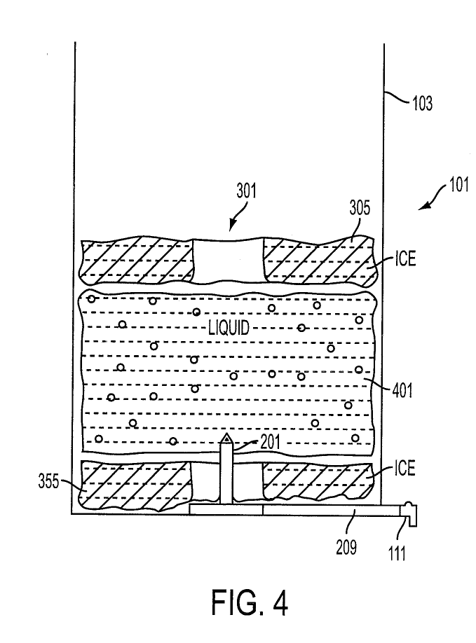

While the dispensing container (101) for holding the fluid-filled bags can be shaped generally in any configuration, in alternate embodiments, the dispenser (101) for holding the fluid-filled bag (401) is more like that shown in FIG. 5 instead of that shown in FIG. 4. In the embodiment of FIG. 5, the base of the dispenser (101) is not rounded (as shown in FIG. 4) but is instead generally rectangular. Further, the dispenser (101) includes a sloped base (701) to direct water in the bag (401) toward the spike (201). In such an embodiment, the temperature alteration pack (305) will be generally shaped to be consistent with the shape of the dispenser (101). So, for instance, a temperature alteration pack (305) for use with the dispenser (101) shown in FIG. 5 may be generally rectilinear. It may also be designed to have fold points which will be positioned above the low point in the dispenser (101) base (701). In this way, the pack (305) may be able to flex to remain in contact with the bag (401) regardless of how much fluid remains in the bag (401).

In another example, a temperature alteration pack (355) for use as a bottom temperature alteration pack (as in FIG. 4) which may be designed for use with the container (101) shown in FIG. 5 such that it would generally conform to the shape of the bottom of the container (101) when placed therein, or may be a rigid temperature alteration pack manufactured in a form that generally fits in conformance with the bottom of the container (101).

It should also be recognized that, depending on the embodiment, the support (103) of the dispenser (101) may include insulation or be designed so that temperature within the support (103) is generally maintained via insulative or similar properties of the support (103). In such an embodiment, the dispenser (101) will generally include a lid to cover the bag (401) and pack (305).

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A pack for altering the temperature of a fluid, the pack comprising:
an outer membrane having an outer surface and an interior surface wherein said membrane is arranged in a predetermined shape where said inner surface is entirely enclosed by said outer surface and wherein said predetermined shape includes a central opening; and
a material arranged within the outer membrane and adjacent said inner surface;
wherein said outer membrane is capable of allowing efficient heat transfer between said material and a substance in contact with said outer surface of said membrane.

2. The pack of claim 1 wherein said material is a fluid.

3. The pack of claim 1 wherein said material is a gel.

4. The pack of claim 1 wherein said material is non-potable.

5. The pack of claim 1 wherein said membrane and said material are the same substance.

6. The pack of claim 1 wherein said pack is generally circular.

7. The pack of claim 6 wherein said pack is toroidal.

8. The pack of claim 1 wherein said pack is generally rectilinear.

9. A dispensing system for fluid, the system comprising:
a dispenser, said dispenser including:
a support, for holding a bag of fluid;
a spike for penetrating an outer membrane of a bag of fluid; and
a valve, said valve allowing fluid to transfer from said bag, into said spike and out said valve so as to be dispensed to a user;
wherein said dispenser does not include an electrical heating element and does not include an electrical cooling element;
a bag, said bag having an outer membrane and including fluid therein, said outer membrane being penetrated by said spike; and
a pack for altering the temperature of a fluid, the pack comprising:
an outer membrane having an outer surface and an interior surface wherein said membrane is arranged in a predetermined shape where said inner surface is entirely enclosed by said outer surface and wherein said predetermined shape includes a central opening; and
a material arranged within the outer membrane and adjacent said inner surface;
wherein said outer membrane of said pack is capable of allowing efficient heat transfer between said material and said fluid when said outer membrane of said pack is in contact with said membrane of said bag;
wherein said pack is placed onto said bag at a position generally opposed to where said membrane of said bag is penetrated by said spike; and
wherein said central opening of said spike will pass through said central opening of said pack without penetrating said outer membrane of said pack when said fluid in said bag has all been dispensed to said user.

10. The pack of claim 9 wherein said material is a fluid.

11. The pack of claim 9 wherein said material is a gel.

12. The pack of claim 9 wherein said material is non-potable.

13. The pack of claim 9 wherein said membrane and said material are the same substance.

14. The pack of claim 9 wherein said pack is generally circular.

15. The pack of claim 14 wherein said pack is toroidal.

16. The pack of claim 9 wherein said pack is generally rectilinear.

17. A method for altering the temperature of a fluid, the method comprising:
providing a fluid dispensing system, the fluid dispensing system comprising
a dispenser, said dispenser including:
a support, for holding a bag of fluid;
a spike for penetrating an outer membrane of a bag of fluid; and
a valve, said valve allowing fluid to transfer from said bag, into said spike and out said valve so as to be dispensed to a user;
wherein said dispenser does not include an electrical heating element and does not include an electrical cooling element; and
a bag, said bag having an outer membrane and including fluid therein, said outer membrane being penetrated by said spike;
providing a pack for altering the temperature of a fluid, the pack comprising:
an outer membrane having an outer surface and an interior surface wherein said membrane is arranged in a predetermined shape where said inner surface is entirely enclosed by said outer surface and wherein said predetermined shape includes a central opening; and
a material arranged within the outer membrane and adjacent said inner surface,
wherein said outer membrane of said pack is capable of allowing efficient heat transfer between said material and said fluid when said outer membrane of said pack is in contact with said membrane of said bag;
placing said pack onto said bag at a position generally opposed to where said membrane of said bag is penetrated by said spike; and
allowing said spike to pass through said central opening of said pack without penetrating said outer membrane of said pack when said fluid in said bag has all been dispensed to said user.

18. The method of claim 17 further comprising: altering the temperature of said pack by placing said pack in a refrigerator external to said dispenser prior to placing said pack on said bag.

19. The method of claim 17 wherein said fluid is cooled by said method.

20. The method of claim 17 wherein said fluid is heated by said method.
